(19) United States
(12) Patent Application Publication
(10) Pub. No.: US 2026/0143423 A1
(43) Pub. Date: May 21, 2026

(54) HANDLING PENDING DATA USING ASSOCIATION IDENTIFIER OF PEER WIRELESS STATION

(71) Applicant: Qualcomm Incorporated, San Diego, CA (US)

(72) Inventors: Navaneeth Krishnan UNNIKRISHNAN NAIR, Kottarakkara (IN); Raghavender KASTURI, Hyderabad (IN); Mutyala Rao NEELAPALA, Rajahmundry (IN); Vaseem SYED, Khammam (IN); Rajasekhar Reddy CHENCHALA, Nellore (IN); Akhila GOPU, Hyderabad (IN); Subramanyam NALLI, Hyderabad (IN)

(21) Appl. No.: 18/952,359

(22) Filed: Nov. 19, 2024

(51) Int. Cl. H04W 52/02; G06F 3/16

(52) U.S. Cl. CPC H04W 52/0209; G06F 3/162

(57) ABSTRACT

Various aspects of the present disclosure generally relate to wireless communication. In some aspects, a wireless station may receive an indication of an association identifier (AID) associated with a peer wireless station. The wireless station and the peer wireless station may be associated with a wireless communication device. The wireless station may receive, in accordance with the AID, an indication of pending data associated with the peer wireless station. The wireless station may transmit, responsive to the indication of the pending data, a wake-up indication over a wireless personal area network (WPAN) associated with the peer wireless station. Numerous other aspects are described.

### FIELD OF THE DISCLOSURE

Aspects of the present disclosure generally relate to wireless communication and specifically relate to techniques, apparatuses, and methods associated with handling pending data using an association identifier of a peer wireless station.

### BACKGROUND

Wireless communication systems are widely deployed to provide various types of communication content such as voice, video, packet data, messaging, broadcast, and so on. These systems may be multiple-access systems capable of supporting communication with multiple users by sharing the available system resources (for example, time, frequency, and power). A wireless network, for example a wireless local area network (WLAN), such as a Wi-Fi (for example, Institute of Electrical and Electronics Engineers (IEEE) 802.11) network, may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. “Downlink” may refer to the communication link from the AP to the station, and “uplink” may refer to the communication link from the station to the AP.

The AP may be coupled to a network, such as the Internet, and may enable a mobile device to communicate via the network (or communicate with other devices coupled to the access point). A wireless device may communicate with a network device bi-directionally. For example, in a WLAN, a device may communicate with an associated AP via downlink (for example, the communication link from the AP to the device) and uplink (for example, the communication link from the device to the AP). A wireless personal area network (WPAN), which may include a Bluetooth® connection, may provide for short range wireless connections between two or more paired wireless devices. For example, wireless devices such as cellular phones may utilize WPAN communications to exchange information such as audio signals with wireless headsets.

### SUMMARY

Some aspects described herein relate to an apparatus for wireless communication at a wireless station. The apparatus may include one or more memories and one or more processors coupled to the one or more memories. The one or more processors may be individually or collectively configured to cause the wireless station to receive an indication of an association identifier (AID) associated with a peer wireless station, wherein the wireless station and the peer wireless station are associated with a wireless communication device. The one or more processors may be individually or collectively configured to cause the wireless station to receive, in accordance with the AID, an indication of pending data associated with the peer wireless station. The one or more processors may be individually or collectively configured to cause the wireless station to transmit, responsive to the indication of the pending data, a wake-up indication over a wireless personal area network (WPAN) associated with the peer wireless station.

Some aspects described herein relate to a method of wireless communication performed by a wireless station. The method may include receiving an indication of an AID associated with a peer wireless station, wherein the wireless station and the peer wireless station are associated with a wireless communication device. The method may include receiving, in accordance with the AID, an indication of pending data associated with the peer wireless station. The method may include transmitting, responsive to the indication of the pending data, a wake-up indication over a WPAN associated with the peer wireless station.

Some aspects described herein relate to an apparatus for wireless communication. The apparatus may include means for receiving an indication of an AID associated with a peer apparatus, wherein the apparatus and the peer apparatus are associated with a wireless communication device. The apparatus may include means for receiving, in accordance with the AID, an indication of pending data associated with the peer apparatus. The apparatus may include means for transmitting, responsive to the indication of the pending data, a wake-up indication over a WPAN associated with the peer apparatus.

Some aspects described herein relate to a non-transitory computer-readable medium that stores a set of instructions for wireless communication by a wireless station. The set of instructions, when executed by one or more processors of the wireless station, may cause the wireless station to receive an indication of an AID associated with a peer wireless station, wherein the wireless station and the peer wireless station are associated with a wireless communication device. The set of instructions, when executed by one or more processors of the wireless station, may cause the wireless station to receive, in accordance with the AID, an indication of pending data associated with the peer wireless station. The set of instructions, when executed by one or more processors of the wireless station, may cause the wireless station to transmit, responsive to the indication of the pending data, a wake-up indication over a WPAN associated with the peer wireless station.

Aspects generally include a method, apparatus, system, computer program product, non-transitory computer-readable medium, an access point (AP), a station (STA), a mobile device, a peripheral device, an audio device, user equipment, base station, network entity, network node, wireless communication device, and/or processing system as substantially described herein with reference to and as illustrated by the drawings and specification.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (for example, end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (for example, hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 shows a wireless communication network, in accordance with the present disclosure.

FIG. 2 illustrates an example of a wireless communication network that supports extended personal audio networks (XPANs) in accordance with the present disclosure.

FIG. 3 is a diagram illustrating an example of a wireless communication device, in accordance with the present disclosure.

FIG. 4 is a diagram illustrating an example associated with signaling for handling pending data using an association identifier (AID) of a peer wireless station, in accordance with the present disclosure.

FIG. 5 is a diagram illustrating an example associated with handling pending data using duplicate AIDs, in accordance with the present disclosure.

FIG. 6 is a diagram illustrating an example process performed, for example, at a wireless station or an apparatus of a wireless station, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

An access point (AP) or a handset may grant network access to a client, which may allow the client to exchange data with the AP or handset. As part of the procedure for granting network access, the AP or handset may create an association identifier (AID) for the client, which is a number that uniquely identifies a connection between the AP or handset and the client. After the client has been granted network access, the AID may be used in further communications between the AP or handset and the client to identify the client.

In some examples, a client (e.g., an earbud) may enter a delivery traffic indication message (DTIM) power-saving mode, which may enable the client to conserve battery power. In the DTIM power-saving mode, the client may persist in a sleep mode and periodically enter an active mode to monitor for a DTIM. For example, the AP or handset may transmit the DTIM (e.g., a beacon) during a periodic beacon interval. The DTIM may indicate whether the client has any data pending at the AP or handset. For example, the DTIM may include a traffic indication map (TIM) information element (IE) in one or more beacon frames. For example, the TIM IE may include a bitmap that contains one or more bits corresponding to one or more respective AIDs and indicating whether any data is pending for the client(s) that have been assigned the AID(s). Additionally, or alternatively, the DTIM may indicate whether any broadcast or multicast data is pending. If the DTIM indicates that data is pending for a client, then the client may transmit a null frame (e.g., a PS-0 frame), and the AP or handset may respond by transmitting one or more packets that include the pending data. For example, the AP or handset may transmit one or more broadcast or multicast packets to the client.

How often a client monitors for a DTIM may depend on a DTIM value, where a higher DTIM value indicates a longer sleep cycle between client wake-ups to monitor for DTIM transmissions. For example, a client can dynamically transition to a higher DTIM value based at least in part on a learned data pattern, which may help to further conserve battery power and thereby increase power saving. Higher DTIM values may cause the client to miss broadcast, multicast, and/or unicast packets transmitted from the AP. For example, the client may not wake up to monitor for the DTIM and check for pending data, and because the AP or handset may be unaware of the DTIM value, the client may miss the broadcast, multicast, and/or unicast packets. For example, the client may miss a broadcast or multicast packet that was indicated as pending in the DTIM. Additionally, or alternatively, the client may miss a unicast packet that was dropped at the AP or handset due to lack of available buffers at the AP or handset. As a result, dynamic changes in DTIM values may lead to dropped packets (e.g., broadcast, multicast, and/or unicast packets) and/or increase latency.

Various aspects relate generally to an enhanced power-save mode for clients. In some aspects, a client (e.g., an earbud) may be notified of an AID of a peer client (e.g., another earbud). In some examples, the peer client may then dynamically transition to a higher DTIM value than a DTIM value of the client. The client may receive an indication of pending data at the AP and/or handset. The client may use the AID of the peer client to identify that the pending data is for the peer client, and transmit a wake-up signal to the peer client. The peer client may receive the wake-up signal, exit a DTIM power-saving mode, and receive the pending data.

In some aspects, when the client connects to the AP and/or handset, the AP and/or handset may allocate a first AID to the client and a second AID for the peer client. When the peer client connects to the AP and/or handset, the AP and/or handset may allocate a third AID to the peer client and a fourth AID for the client. In some aspects, the AP and/or handset may allocate a first AID to the client when the client connects to the AP and/or handset, and a second AID to the peer client when the peer client connects to the AP and/or handset. The client and the peer client may then exchange the first AID and the second AID.

Particular aspects of the subject matter described in this disclosure can be implemented to realize one or more of the following potential advantages. In some examples, the described techniques can be used to enable the peer client to implement dynamic DTIM (thereby conserving battery power and increasing power savings) and wake up to receive pending data. As a result, a quantity of dropped packets (e.g., broadcast, multicast, and/or unicast packets) may be reduced. Furthermore, the peer client may wake up during a dynamic DTIM sleep cycle to receive pending data, which may reduce latency that would otherwise be caused by dynamic DTIM.

Exchanging the first and second AIDs may help to reduce a quantity of AIDs reserved by the AP and/or handset, thereby reducing memory and/or processing resource utilization at the AP and/or handset. For example, the quantity of AIDs may be reduced from four (e.g., two AIDs per client) to two (e.g., one AID per client).

Several aspects of wireless communication networks will now be presented with reference to various apparatuses and techniques. These apparatuses and techniques will be described in the following detailed description and illustrated in the accompanying drawings by various blocks, modules, components, circuits, steps, processes, and/or algorithms, among other examples (collectively referred to as “elements”). These elements may be implemented using hardware, software, or combinations thereof. Whether such elements are implemented as hardware or software depends upon the particular application and design constraints imposed on the overall system.

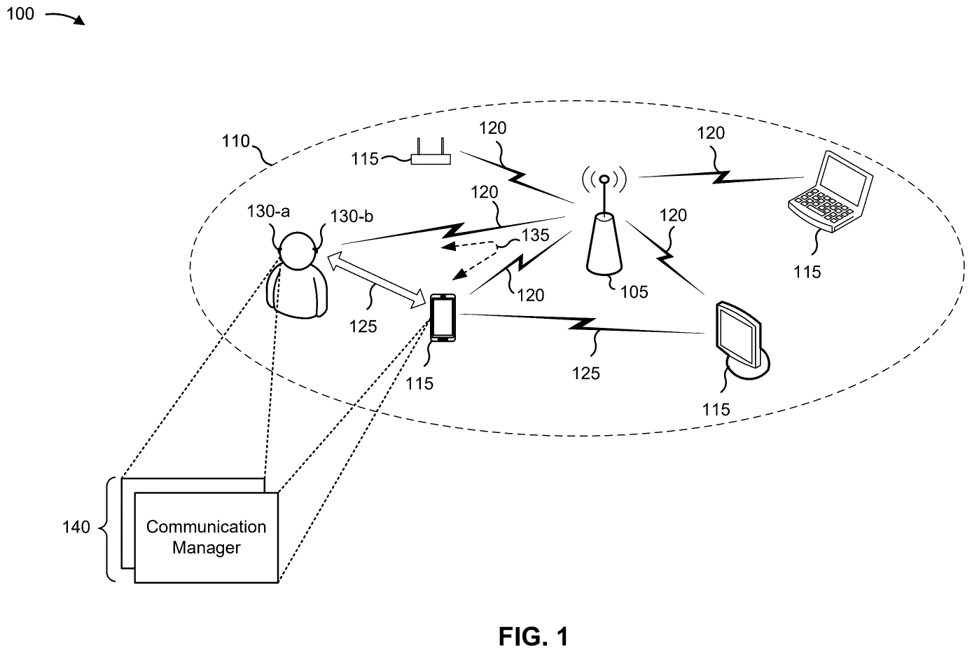

FIG. 1 shows a wireless communication network 100, in accordance with the present disclosure. The wireless communication network 100 may be a wireless local area network (WLAN) or a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include an AP 105 and multiple associated devices 115 (such as stations (STAs) or SAPs). The devices 115 may include mobile stations, personal digital assistants (PDAs), other handheld devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors, or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and/or vehicles, among other examples.

The AP 105 and the associated devices 115 (for example, associated STAs) may represent a basic service set (BSS) or an extended service set (ESS). A BSS includes devices that communicate with each other, and an ESS may include multiple BSSs or one or more BSSs and associated wired networks. The various devices 115 in the network are able to communicate with one another through the AP 105. The AP 105 may support a coverage area 110, which may represent a basic service area (BSA) of the wireless communication network 100. An extended network station (not shown) associated with the wireless communication network 100 may be connected to a wired or wireless distribution system that may allow multiple APs 105 to be connected in an ESS.

While only one AP 105 is shown in FIG. 1, the wireless communication network 100 can include multiple APs 105. The AP 105 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a RAN, including Open-RAN (O-RAN) network entities, such as a central unit (CU), a distributed unit (DU) or a radio unit (RU).

Although not shown in FIG. 1, a device 115 may be located in the intersection of more than one coverage area 110 and may associate with more than one AP 105. A single AP 105 and an associated set of devices 115 may be referred to as a BSS. A distribution system (not shown) may be used to connect APs 105 in an ESS. In some cases, the coverage area 110 of an AP 105 may be divided into sectors (also not shown). The wireless communication network 100 may include APs 105 of different types (for example, a metropolitan area, or a home network) with varying and/or overlapping coverage areas 110. Two devices 115 may also communicate directly via a direct wireless communication link 125 regardless of whether both devices 115 are in the same coverage area 110. Examples of direct wireless communication links 125 may include Wi-Fi Direct connections, Wi-Fi Tunneled Direct Link Setup (TDLS) links, and other group connections. Devices 115 and APs 105 may communicate according to the WLAN radio and baseband protocol for physical and medium access control (MAC) layers from IEEE 802.11 and versions including 802.11b, 802.11g, 802.11a, 802.11n, 802.11ac, 802.11ad, 802.11ah, and/or 802.11ax, among other examples. In other implementations, peer-to-peer connections or ad hoc networks may be implemented within wireless communication network 100.

In some cases, a device 115 (or an AP 105) may be detectable by a central AP 105, but not by other devices 115 in the coverage area 110 of the central AP 105. For example, one device 115 may be at one end of the coverage area 110 of the central AP 105 while another device 115 may be at the other end. Thus, both devices 115 may communicate with the AP 105, but may not receive the transmissions of the other. This may result in colliding transmissions for the two devices 115 in a contention-based environment (for example, carrier sense multiple access with collision avoidance (CSMA/CA)) because the devices 115 may not refrain from transmitting on top of each other. A device 115 whose transmissions are not identifiable, but that is within the same coverage area 110 may be known as a hidden node. CSMA/CA may be supplemented by the exchange of a request-to-send (RTS) packet transmitted by a sending device 115 (or AP 105) and a clear-to-send (CTS) packet transmitted by the receiving device 115 (or AP 105). This may alert other devices within range of the sender and receiver not to transmit for the duration of the primary transmission. Thus, RTS and/or CTS may help mitigate a hidden node problem.

The wireless communication network 100 may include an AP 105, devices 115 (for example, which may be referred to as source devices or central devices), and paired devices 115 (for example, which may be referred to as sink devices or peripheral devices) implementing WLAN communications (for example, Wi-Fi communications) and/or Bluetooth communications. For example, devices 115 may include cell phones, user equipment (UEs), STAs, mobile stations, PDAs, other handheld devices, netbooks, notebook computers, tablet computers, laptops, or some other suitable devices. Paired devices 115 may include Bluetooth-enabled devices capable of pairing with other Bluetooth-enabled devices (for example, such as devices 115), which may include wireless audio devices (for example, headsets, earbuds, speakers, earpieces, headphones), display devices (for example, televisions or computer monitors), microphones, meters, and/or valves, among other examples. As one example, the paired devices 115 may include a wireless audio device 130-a and a wireless audio device 130-b as shown by FIG. 1 (for example, wireless earbuds), and the paired devices 115 may alternatively or additionally communicate with the AP 105. In some aspects, a paired device 115 may communicate with a device 115 using the AP 105.

“Bluetooth communications” may refer to a short-range communication protocol and may be used to connect and exchange information between devices 115 and paired devices 115 (for example, between mobile phones, computers, digital cameras, wireless headsets, speakers, keyboards, mice or other input peripherals, and similar devices). Bluetooth systems (for example, aspects of wireless communication network 100) may be organized using a central-peripheral relationship employing a time-division duplex protocol having, for example, defined time slots of 625 microseconds, in which transmission alternates between the central device (for example, a device 115) and one or more peripheral devices (for example, paired devices 115). In some examples, “device” 115 may generally refer to a central device, and “paired device” 115 may refer to a peripheral device in the wireless communication network 100. Therefore, in some examples, a device may be referred to as either a device 115 or a paired device 115 based on the Bluetooth role configuration of the device. That is, designation of a device as either a device 115 or a paired device 115 may not necessarily indicate a distinction in device capability, but rather may refer to or indicate roles held by the device in the wireless communication network 100. Generally, “device” 115 may refer to a wireless communication device capable of wirelessly exchanging data signals with another device (for example, a paired device 115), and “paired device” 115 may refer to a device operating in a peripheral role, or to a short-range wireless communication device capable of exchanging data signals with the device 115 (for example, using Bluetooth communication protocols).

A direct wireless communication link 125 may be established between two Bluetooth-enabled devices (for example, between a device 115 and a paired device 115) and may provide for communications or services (for example, according to some Bluetooth profiles). The controller stack may be responsible for setting up direct wireless communication links 125, such as asynchronous connection-oriented links (or asynchronous connection-oriented connections), synchronous connection-orientated (SCO) links (or SCO connections), extended synchronous connection-oriented (eSCO) links (or eSCO connections), and/or other logical transport channel links. For example, a Bluetooth connection may be an eSCO connection for voice calls (for example, which may allow for retransmission), and/or an asynchronous connection-less (ACL) connection for music streaming (for example, advanced audio distribution profile (A2DP)), among other examples. eSCO packets may be transmitted in predetermined time slots (for example, 6 Bluetooth slots each for eSCO). The regular interval between the eSCO packets may be specified when the Bluetooth link is established. The eSCO packets to/from a specific device (for example, paired device 115) are acknowledged and may be retransmitted if not acknowledged during a retransmission window. In addition, audio may be streamed between a device 115 and a paired device 115 using an ACL connection (for example, an A2DP profile). In some cases, the ACL connection may occupy 1, 3, or 5 Bluetooth slots for data or voice. Other Bluetooth profiles supported by Bluetooth-enabled devices may include Bluetooth Low Energy (BLE) (for example, providing considerably reduced power consumption and cost while maintaining a similar communication range), human interface device (HID) profile (for example, providing low latency links with low power requirements), etc.

A device 115 may, in some examples, be capable of both Bluetooth and WLAN communications. For example, WLAN and Bluetooth components may be co-located within a device, such that the device may be capable of communicating according to both Bluetooth and WLAN communication protocols, as each technology may offer different benefits or may improve user experience in different conditions. In some examples, Bluetooth and WLAN communications may share a same medium, such as the same unlicensed frequency medium. In such examples, a device 115 may support WLAN communications via AP 105 (for example, over communication links 120). The AP 105 and the associated devices 115 may represent a BSS or an ESS. The various devices 115 in the network may be able to communicate with one another through the AP 105. In some cases the AP 105 may be associated with a coverage area, which may represent a BSA.

Devices 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, and/or 802.11ax. In other examples, peer-to-peer connections or ad hoc networks may be implemented within wireless communication network 100, and devices may communicate with each other via direct wireless communication links 125 (for example, Wi-Fi Direct connections, Wi-Fi TDLS links, peer-to-peer communication links, or other peer or group connections). AP 105 may be coupled to a network (such as the Internet) and may enable a device 115 to communicate via the network (or communicate with other devices 115 coupled to the AP 105). A device 115 may communicate with a network device bi-directionally. For example, in a WLAN, a device 115 may communicate with an associated AP 105 via downlink (for example, the communication link from the AP 105 to the device 115) and uplink (for example, the communication link from the device 115 to the AP 105).

In some examples, content, media, and/or audio, among other examples, exchanged between a device 115 and a paired device 115 may originate from a WLAN. In some examples, device 115 may receive audio from an AP 105 (for example, via WLAN communications), and the device 115 may then relay or pass the audio to the paired device 115 (for example, via Bluetooth communications and/or the AP 105). As one example, the device 115 may relay or pass the audio to the paired device 115 via the direct wireless communication link 125. Alternatively, or additionally, the device 115 may relay and/or pass the audio to the paired device via the AP 105 as shown by reference number 135. In some examples, certain types of Bluetooth communications (for example, such as high quality or high definition (HD) Bluetooth) may require enhanced quality of service. For example, in some examples, delay-sensitive Bluetooth traffic may have a higher priority than WLAN traffic.

In some examples, a wireless communication device (for example, the AP 105 and/or a device 115) may support applications associated with low-latency or lossless audio to one or more other devices, such as one or more personal audio devices. For example, a wireless communication device may support applications and use cases associated with ultra-low latency (ULL), such as ULL gaming, or streaming lossless audio to one or more personal audio devices (for example, peripheral devices) of a user or one or more headset devices (for example, AR/VR/MR/XR headset devices). In scenarios in which a user uses two or more peripheral devices (for example, a wireless audio device 130-a and a wireless audio device 130-b), the wireless communication device may support an extended personal audio network (XPAN) enabling communication with the two or more peripheral devices.

In some aspects, a wireless station (for example, a device 115, a wireless audio device 130-a, and/or a wireless audio device 130-b) may include a communication manager 140. As described in more detail elsewhere herein, the communication manager 140 may receive an indication of an AID associated with a peer wireless station, wherein the wireless station and the peer wireless station are associated with a wireless communication device; receive, in accordance with the AID, an indication of pending data associated with the peer wireless station; and transmit, responsive to the indication of the pending data, a wake-up indication over a WPAN associated with the peer wireless station. Additionally, or alternatively, the communication manager 140 may perform one or more other operations described herein.

As indicated above, FIG. 1 is provided as an example. Other examples may differ from what is described with regard to FIG. 1.

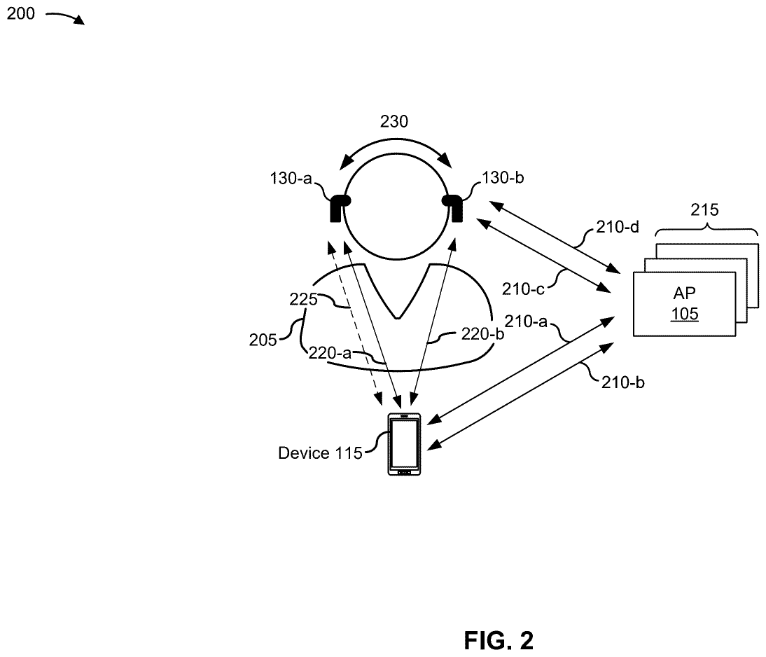

FIG. 2 illustrates an example of a wireless communication network 200 that supports XPANs in accordance with the present disclosure. The wireless communication network 200 may implement or be implemented to realize aspects of the wireless communication network 100. For example, the wireless communication network 200 illustrates communication between an AP 105, a device 115 (for example, a handset or handheld device), and a wireless audio device 130-a and a wireless audio device 130-b of a user 205 (for example, examples of audio devices and/or peripheral devices), which may be examples of corresponding devices as illustrated by and described with reference to FIG. 1. In some examples, the device 115, the wireless audio device 130-a, and the wireless audio device 130-b may support a signaling-based mechanism according to which the device 115 may transmit an indication of a set of updated parameters to each of the wireless audio device 130-a and the wireless audio device 130-b via one or audio data packets.

In some examples, the device 115 may communicate with the AP 105 via one or both of a link 210-a and a link 210-b, which may be examples of infrastructure links between the AP 105 and the device 115. Alternatively, or additionally, the AP 105 may communicate with the wireless audio device 130-a and/or the wireless audio device 130-b via one or both of a link 210-c and a link 210-d, respectively. In some examples, the wireless audio device 130-a and the wireless audio device 130-b may be connected to a same AP 105 as the device 115. In other aspects, the wireless audio device 130-a and the wireless audio device 130-b may be connected to a different AP 105 than the device 115. Accordingly, and as shown by reference number 215, the device 115, the wireless audio device 130-a, and/or the wireless audio device 130-b may communicate with one another via multiple APs 105. The link 210-a may be an example of a 2.4 GHz link between the AP 105 and the device 115, and the link 210-b may be an example of a 5 GHz link or a 6 GHz link between the AP 105 and the device 115. In some examples, the link 210-c and/or the link 210-d may be a 2.4 GHz link, a 5 GHz, and/or a 6 GHz link.

The device 115 may communicate wirelessly with each of the wireless audio device 130-a and the wireless audio device 130-b, where each of the wireless audio device 130-a and the wireless audio device 130-b may be associated with an XPAN of the device 115. For example, the device 115 may communicate with the wireless audio device 130-a via a link 220-a and may communicate with the wireless audio device 130-b via a link 220-b, where the link 220-a and the link 220-b may be referred to or understood as XPAN links. The link 220-a may be an example of a 5 GHz link or a 6 GHz link and the link 220-b may be an example of a 5 GHz link or a 6 GHz link. Additionally, in some examples, the device 115 may communicate with the wireless audio device 130-a, which may be an example of a primary earbud, via a communication link 225. The communication link 225 may be an example of a Bluetooth link between the device 115 and the wireless audio device 130-a. The wireless audio device 130-a and the wireless audio device 130-b, which may be an example of a secondary audio device, may communicate with each other via a link 230, which may be an example of a Bluetooth link between the wireless audio device 130-a and the wireless audio device 130-b.

The device 115 may communicate with the wireless audio device 130-a and/or the wireless audio device 130-b via one or more APs 105. To illustrate, the device 115 may communicate with a first AP 105 via the link 210-a and/or the link 210-b. The first AP 105 may be connected to a second AP 105, and the second AP 105 may be connected to the wireless audio device 130-a and/or the wireless audio device 130-b via the link 210-c and/or the link 210-d. Accordingly, the device 115 may communicate with the wireless audio device 130-a and/or the wireless audio device 130-b based at least in part on communicating with the first AP 105, the first AP 105 communicating with the second AP 105, and the second AP 105 communicating with the wireless audio device 130-a and/or the wireless audio device 130-b. However, in other examples, the device 115, the wireless audio device 130-a, and/or the wireless audio device 130-b may be connected to a same AP 105.

As indicated above, FIG. 2 is provided as an example. Other examples may differ from what is described with regard to FIG. 2.

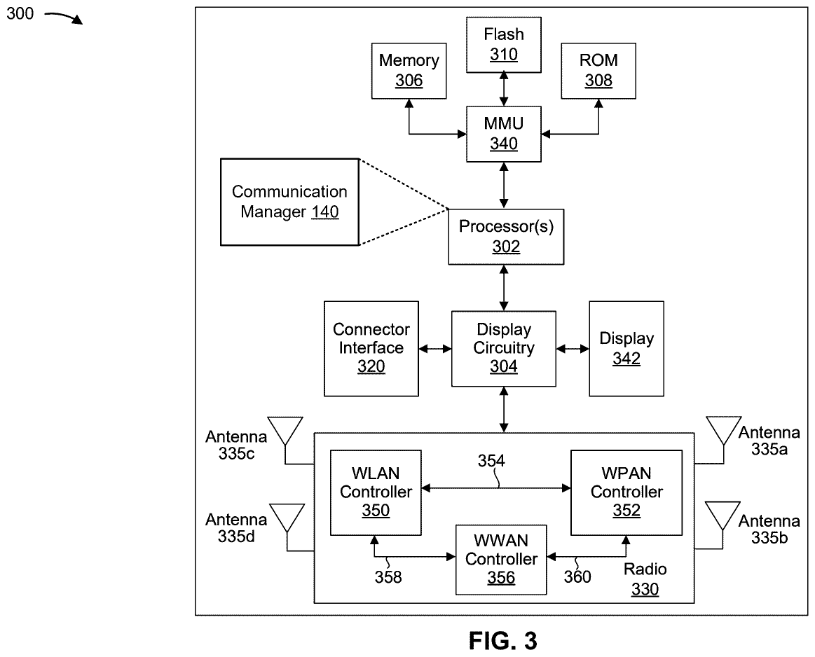

FIG. 3 is a diagram illustrating an example of a wireless communication device 300, in accordance with the present disclosure. In some aspects, the wireless communication device 300 may be an example of the AP 105, the device 115, and/or the wireless audio device 130 described above. In some examples, the AP 105, the device 115, and/or the wireless audio device 130 may include one or more wireless communication devices 300 and/or one or more components of wireless communication device 300.

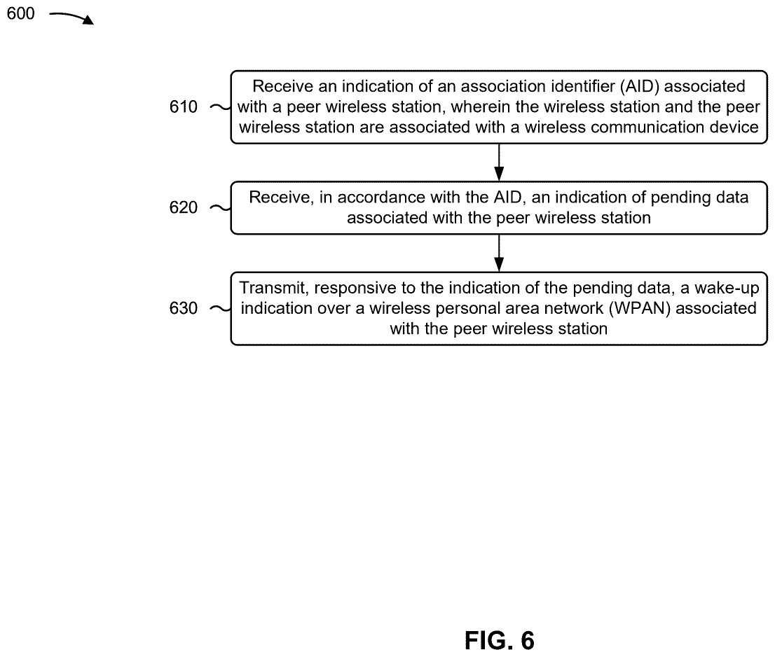

In some examples, the wireless communication device 300 is configured to perform the process 600 of FIG. 6, or other processes as described herein. The wireless communication device 300 may include one or more chips, system-on-chips (SoCs), chipsets, packages, components or devices that individually or collectively constitute or comprise a processing system. The processing system may interface with other components of the wireless communication device 300, and may generally process information (such as inputs or signals) received from such other components and output information (such as outputs or signals) to such other components. In some examples, an example chip may include a processing system, a first interface to output or transmit information and a second interface to receive or obtain information. For example, the first interface may refer to an interface between the processing system of the chip and a transmission component, such that the wireless communication device 300 may transmit the information output from the chip. In such an example, the second interface may refer to an interface between the processing system of the chip and a reception component, such that the wireless communication device 300 may receive information that is passed to the processing system. In some such examples, the first interface also may obtain information, such as from the transmission component, and the second interface also may output information, such as to the reception component.

As shown in FIG. 3, the wireless communication device 300 may include processor (or “processing”) circuitry in the form of one or multiple processors, such as processor(s) 302. The processor (or “processing”) circuitry may be in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processor(s) 302 may execute program instructions for the wireless communication device 300. One or more of the processor(s) 302 may be individually or collectively configurable or configured to perform various functions or operations described herein. A group of processor(s) 302 collectively configurable or configured to perform a set of functions may include a first processor configurable or configured to perform a first function of the set and a second processor configurable or configured to perform a second function of the set, or may include the group of processors all being configured or configurable to perform the set of functions.

The wireless communication device 300 may also include a display 342 that can perform graphics processing and present information to a user. The processor(s) 302 may also be coupled to memory management unit (MMU) 340, which may be configured to receive addresses from the processor(s) 302 and translate the addresses to address locations in memory such as memory 306, read-only memory (ROM) 308, or flash memory 310 and/or to address locations in other circuits or devices, such as the display circuitry 304, radio 330, connector interface 320, and/or display 342. The MMU 340 may also be configured to perform memory protection and page table translation or set up. In some aspects, the MMU 340 may be included as a portion of the processor(s) 302. In some aspects, the wireless communication device 300 may include a communication manager (for example, communication manager 140) that controls the wireless communication device 300 or processor(s) 302 to perform the processes described herein.

In some examples, the processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”), such as the memory 306, ROM 308, and/or flash memory 310. One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

The processor(s) 302 may be coupled to other circuits of the wireless communication device 300. For example, the wireless communication device 300 may include various memory types, a connector interface 320 through which the wireless communication device 300 can communicate with the computer system, and wireless communication subsystems that can transmit data to, and receive data from, other devices based on one or more wireless communication standards or protocols. For example, in some aspects, the wireless communication subsystems may include (but are not limited to) a WLAN subsystem, a WPAN subsystem, and/or a cellular subsystem (such as an LTE or NR subsystem). The wireless communication device 300 may include multiple antennas 335a, 335b, 335c, and/or 335d for performing wireless communication with, for example, wireless communication devices in a WPAN.

The wireless communication device 300 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware element, such as a field-programmable gate array (FPGA), and/or an application specific integrated circuit (ASIC).

In certain aspects, the radio 330 may include separate controllers configured to control communications for various respective radio access technology (RAT) protocols. For example, as shown in FIG. 3, radio 330 may include a WLAN controller 350 that manages WLAN communications, a WPAN controller 352 that manages Bluetooth, BLE, and/or other suitable WPAN communications, and a wireless wide area network (WWAN) controller 356 that manages WWAN communications. In some aspects, the wireless communication device 300 may store and execute a WLAN software driver for controlling WLAN operations performed by the WLAN controller 350, a WPAN software driver for controlling WPAN operations performed by the WPAN controller 352, and/or a WWAN software driver for controlling WWAN operations performed by the WWAN controller 356.

In some aspects, a first coexistence interface 354 (such as a wired interface) may be used for sending information between the WLAN controller 350 and the WPAN controller 352. Additionally, or alternatively, in some aspects, a second coexistence interface 358 may be used for sending information between the WLAN controller 350 and the WWAN controller 356. Additionally, or alternatively, in some aspects, a third coexistence interface 360 may be used for sending information between the WPAN controller 352 and the WWAN controller 356. In some examples, one or more of the WLAN controller 350, the WPAN controller 352, and/or the WWAN controller 356 may be implemented as hardware, software, firmware or some combination thereof.

In some aspects, the WLAN controller 350 may be configured to communicate with a second device in a WPAN using a WLAN link using one or more, some, or all of the antennas 335a, 335b, 335c, and 335d. In other configurations, the WPAN controller 352 may be configured to communicate with at least one second device in a WPAN using one or more, some, or all of the antennas 335a, 335b, 335c, and 335d. In other configurations, the WWAN controller 356 may be configured to communicate with a second device in a WPAN using one or more, some, or all of the antennas 335a, 335b, 335c, and 335d. The WLAN controller 350, the WPAN controller 352, and/or the WWAN controller 356 may be configured to adjust a wakeup time interval and a shutdown time for the wireless communication device 300.

A short-range wireless communications protocol, such as Bluetooth (BT), BLE, and/or basic rate (BR)/enhanced data rate (EDR), may include and/or may use one or more other communications protocols, for example, to establish and maintain communications links. In some examples, the wireless communication device 300 may establish a communications link with one or more peripheral devices, such as a wireless headset or wireless earbuds, according to at least one communications protocol for short-range wireless communications. In some aspects, the communications link may include a communications link that adheres to a protocol included and/or for use with BT, BLE, and/or BR/EDR, among other examples. In one aspect, the communications link may include an asynchronous connection-oriented logical transport, sometimes referred to as an ACL link. When operating as an ACL link, the communications link may allow the wireless communication device 300 to connect or “pair” with a peripheral device. The connection is asynchronous in that the two devices may not need to synchronize, timewise, data communications between each other to permit communication of data packets via the communications link.

In some examples, a logical link control and adaptation protocol (L2CAP) may be used within a BT protocol stack (not shown in FIG. 3). An L2CAP connection may be established after an ACL link has been established. Reference to L2CAP in the present disclosure may be further applicable to enhanced L2CAP (EL2CAP), which may be an enhanced version of the L2CAP protocol that enables multiplexing of multiple logical data channels via a single radio connection.

In some examples, the communications link may include an A2DP link. For example, an A2DP link may provide a point-to-point link between a source device, such as the wireless communication device 300, and a sink device, such as the wireless earbuds 130-a and 130-b. With an A2DP link, data packets including audio may be transmitted over an ACL channel, and other information (for example, for controlling the audio stream) may be transmitted over a separate control channel. The data packets may occur non-periodically.

In some examples, the communications link may support synchronous logical transport mechanisms between a source device and a peripheral device. For example, the communications link 116 may include an SCO link that provides a symmetric point-to-point link between the source device and the peripheral device using time slots reserved for BT communications. In some aspects, an SCO link may not support retransmission of data packets, which may be unsatisfactory in audio streaming and/or voice call use cases in which a dropped audio or voice packet may reduce the quality of the user experience. Accordingly, in some aspects, the communications link may include an eSCO link. An eSCO link may provide a symmetric or asymmetric point-to-point link between a source device and a peripheral device using time slots reserved for BT communications, and may also provide for a retransmission window following the reserved time slots. Because retransmissions may be facilitated using the retransmission window, an eSCO link may be suitable for audio streaming and/or voice call use cases because a dropped audio or voice packet may be retransmitted, and therefore the probability of successfully receiving a data packet may be increased.

In some aspects, the communications link may include an isochronous (ISO) link. When operating as an ISO link, the communications link 116 may combine some features of both synchronous and asynchronous links. For example, a stream on an ISO link may begin with a start packet, and then data packets may be asynchronously transmitted. On an ISO link, the number of retransmission attempts by a transmitting device may be limited. Thus, if a receiving device is unable to decode a data packet within the limited number of retransmission attempts, then the data packet may be dropped, and the receiving device may continue to receive the stream without data from the dropped data packet.

In some aspects, the wireless station (for example, a device 115, a wireless audio device 130-a, and/or a wireless audio device 130-b) includes means for receiving an indication of an AID associated with a peer wireless station, wherein the wireless station and the peer wireless station are associated with a wireless communication device; means for receiving, in accordance with the AID, an indication of pending data associated with the peer wireless station; and/or means for transmitting, responsive to the indication of the pending data, a wake-up indication over a WPAN associated with the peer wireless station. In some aspects, the means for the wireless station to perform operations described herein may include, for example, one or more of antennas 335a-335d, WPAN controller 352, WLAN controller 350, radio 330, and/or processor 302, among other examples.

The number and arrangement of components shown in FIG. 3 are provided as an example. In practice, wireless communication device 300 may include additional components, fewer components, different components, or differently arranged components than those shown in FIG. 3. Additionally, or alternatively, a set of components (for example, one or more components) of wireless communication device 300 may perform one or more functions described as being performed by another set of components of wireless communication device 300.

In some examples, a wireless audio device 130 can dynamically transition to a higher DTIM value based at least in part on a learned data pattern, which may help to further conserve battery power and thereby increase power saving. However, higher DTIM values may cause the wireless audio device 130 to miss broadcast, multicast, and/or unicast packets transmitted from the device 115 (e.g., the AP 105 or a handset). For example, the wireless audio device 130 may not wake up to monitor for the DTIM and check for pending data, and because the device 115 may be unaware of the DTIM value, the wireless audio device 130 may miss the broadcast, multicast, and/or unicast packets. For example, the wireless audio device 130 may miss a broadcast or multicast packet that was indicated as pending in the DTIM. Additionally, or alternatively, the wireless audio device 130 may miss a unicast packet that was dropped at the device 115 due to lack of available buffers at the device 115. As a result, dynamic changes in DTIM values may lead to dropped packets (e.g., broadcast, multicast, and/or unicast packets) and/or increase latency.

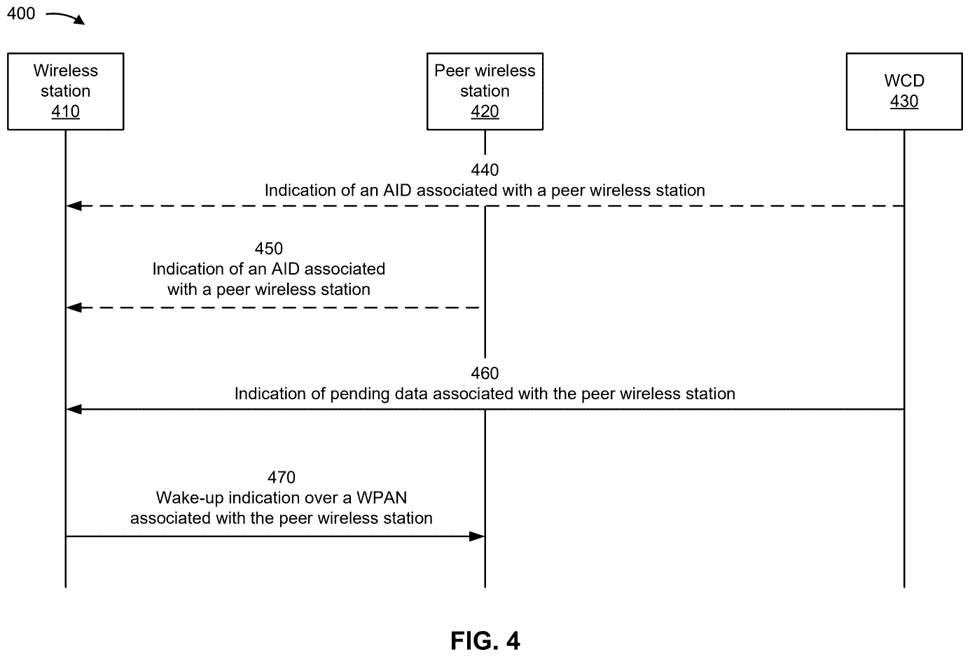

FIG. 4 is a diagram illustrating an example 400 associated with signaling for handling pending data using an AID of a peer wireless station, in accordance with the present disclosure. As shown in FIG. 4, a wireless station 410, a peer wireless station 420, and a wireless communication device 430 may communicate with one another. In some aspects, the wireless station may be the wireless audio device 130-a, and the peer wireless station may be the wireless audio device 130-b. In some aspects, the wireless communication device 430 may be the AP 105, the device 115 (for example, a handset or handheld device), or the like.

In some aspects, the wireless station 410 and the peer wireless station 420 may be associated with the wireless communication device 430. The wireless station 410 may be associated with the wireless communication device 430 in that the wireless station 410 and the wireless communication device 430 are connected (e.g., via a WLAN connection). The peer wireless station 420 may be associated with the wireless communication device 430 in that the peer wireless station 420 and the wireless communication device 430 are connected (e.g., via a WLAN connection). Thus, both the wireless station 410 and the peer wireless station 420 may be connected to AP.

As shown by reference number 440 and reference number 450, the wireless station 410 may receive an indication of an AID associated with the peer wireless station 420. The AID may be associated with the peer wireless station 420 in that the AID may uniquely identify a connection (e.g., the WLAN connection) between the wireless communication device 430 and the peer wireless station 420.

In some aspects, the AID associated with the peer wireless station 420 and an AID associated with the wireless station 410 are consecutive AIDs. The AID may be associated with the wireless station 410 in that the AID may uniquely identify a connection (e.g., the WLAN connection) between the wireless communication device 430 and the wireless station 410. Thus, the wireless communication device 430 may dedicate multiple, consecutive AIDs. For example, the wireless communication device 430 may dedicate a first AID for the connection between the wireless communication device 430 and the wireless station 410, and the wireless communication device 430 may dedicate a second AID for the connection between the wireless communication device 430 and the peer wireless station 420).

In some aspects, the peer wireless station 420 may be associated with a first AID and a second AID, and the wireless station 410 may be associated with a third AID and a fourth AID. The peer wireless station 420 may be associated with the first AID and the second AID in that the first AID and the second AID may each identify a connection (e.g., a WLAN connection) between the wireless communication device 430 and the peer wireless station 420. The wireless station 410 may be associated with the third AID and the fourth AID in that the third AID and the fourth AID may each identify a connection (e.g., a WLAN connection) between the wireless communication device 430 and the wireless station 410. For example, the wireless communication device 430 may dedicate consecutive, multiple AIDs (e.g., the first and third AIDs) in response to the wireless station 410 initiating a connection, and the wireless communication device 430 may dedicate additional consecutive, multiple AIDs (e.g., the second and fourth AIDs) in response to the peer wireless station 420 initiating a connection. In some examples, all wireless stations (e.g., the wireless station 410 and the peer wireless station 420) may be aware of the consecutive, multiple AIDs.

As shown by reference number 440, the wireless station 410 may receive the indication of the AID over a WLAN associated with the wireless communication device 430. The WLAN may be associated with the wireless communication device 430 in that the wireless communication device 430 may be accessible via the WLAN. For example, the wireless communication device 430 and the wireless station 410 may exchange wireless communications over the WLAN. Thus, in some examples, the wireless communication device 430 may transmit the indication of the AID to the wireless station 410 (e.g., via the WLAN).

As shown by reference number 450, the wireless station 410 may receive the indication of the AID over a WPAN associated with the peer wireless station 420. The WPAN may be associated with the peer wireless station 420 in that the peer wireless station 420 may be accessible via the WPAN. For example, the wireless station 410 and the peer wireless station 420 may exchange wireless communications over the WPAN. Thus, in some examples, the peer wireless station 420 may transmit the indication of the AID to the wireless station 410 (e.g., via the WPAN). In some examples, after connecting to the wireless communication device 430, the wireless station 410 and the peer wireless station 420 may share respective AIDs (e.g., by exchanging AID information). For example, in addition to receiving the indication of the AID over the WPAN, the wireless station 410 may transmit an indication of the AID associated with the wireless station 410 over the WPAN.

In some aspects, the wireless station 410 may be associated with a first DTIM sleep cycle, and the peer wireless station 420 may be associated with a second DTIM sleep cycle that is longer than the first DTIM sleep cycle. A wireless station may be associated with a DTIM sleep cycle in that the wireless station remain in a sleep mode for a duration of the DTIM sleep cycle. For example, the wireless station may, in accordance with the DTIM sleep cycle, periodically enter an active mode to monitor for a DTIM. The second DTIM sleep cycle may be longer than the first DTIM sleep cycle in that the second DTIM sleep cycle may have a DTIM value that is greater than a DTIM value of the first DTIM sleep cycle. Thus, the peer wireless station 420 may enter a higher-order DTIM sleep than the wireless station 410. In some examples, first and second DTIM sleep cycles may depend on battery conditions of the wireless station 410 and the peer wireless station 420. For example, the wireless station 410 may enter the first DTIM sleep cycle, and the peer wireless station 420 may enter the second DTIM sleep cycle, based at least in part on a power level of the wireless station 410 being greater than a power level of the peer wireless station 420. Alternatively, if the power levels of the wireless station 410 and the peer wireless station 420 are equal, then a random one of the wireless stations (e.g., the peer wireless station 420) may enter the second DTIM sleep cycle. In some examples, the peer wireless station 420 may enter the second DTIM sleep cycle dynamically (e.g., in response to a power level of the peer wireless station 420 falling below a power level threshold).

As shown by reference number 460, the wireless communication device 430 may transmit, and the wireless station 410 may receive, in accordance with the AID, an indication of pending data associated with the peer wireless station 420. The pending data may be associated with the peer wireless station 420 in that the pending data may be destined to the peer wireless station 420. For example, the wireless communication device 430 may transmit a TIM IE (e.g., a DTIM) that includes a bitmap that contains one or more bits corresponding to one or more respective AIDs and indicating whether any data is pending for the client(s) that have been assigned the AID(s). Additionally, or alternatively, the DTIM may indicate whether any broadcast or multicast data is pending. For example, the wireless communication device 430 may update fields in the TIM IE for both wireless station bands using the AID. The wireless station 410, which may be in a DTIM power-saving mode, may receive the DTIM and identify, based at least in part on the AID, that the peer wireless station 420 has pending data.

As shown by reference number 470, the wireless station 410 may transmit, responsive to the indication of the pending data, a wake-up indication over the WPAN. For example, the wake-up indication may notify the peer wireless station 420 to exit a DTIM power-saving mode (at least temporarily). In some examples, a WPAN module (which may not be asleep) may receive the wake-up indication and, accordingly, wake up a WLAN module that enables communication with the wireless communication device 430. In some examples, after the WLAN module has exited the DTIM power-saving mode, the peer wireless station 420 may transmit a null frame (e.g., a PS-0) to trigger the wireless communication device 430 to transmit the pending data. Thus, the peer wireless station 420 may receive the pending data. In some examples, if the peer wireless station 420 is disconnected, then the wireless station 410 may be notified of the disconnection.

As indicated above, FIG. 4 is provided as an example. Other examples may differ from what is described with respect to FIG. 4.

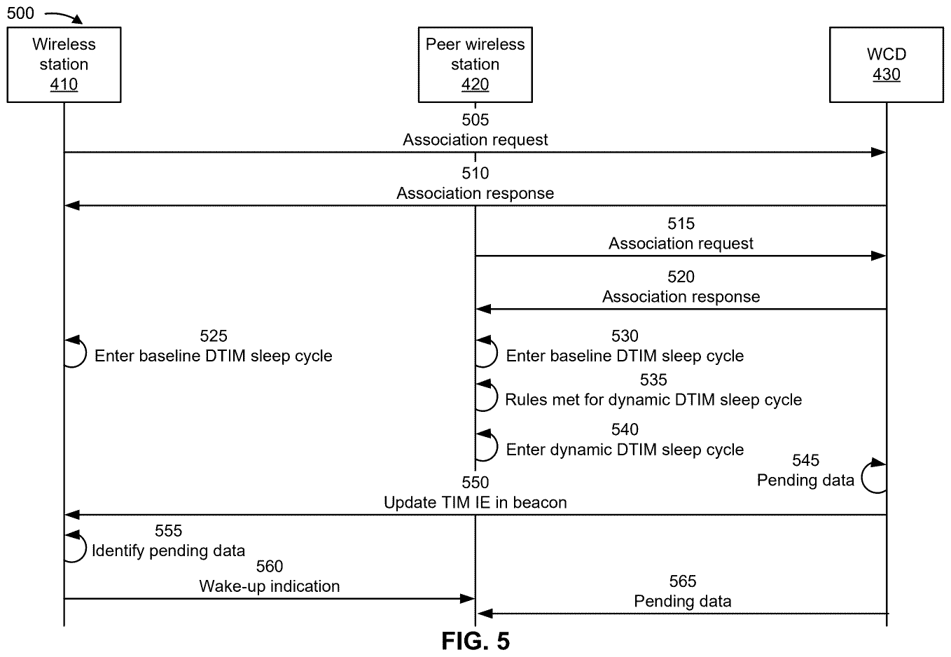

FIG. 5 is a diagram illustrating an example 500 associated with handling pending data using duplicate AIDs, in accordance with the present disclosure. As shown in FIG. 5, the wireless station 410, the peer wireless station 420, and the wireless communication device 430 may communicate with one another. In example 500, the wireless station 410 may receive an indication of an AID associated with the peer wireless station 420, as discussed above in connection with reference number 440 (FIG. 4).

As shown by reference number 505, the wireless station 410 may transmit, and the wireless communication device 430 may receive, an association request. As shown by reference number 510, the wireless communication device 430 may transmit, and the wireless station 410 may receive, an association response. The association response may contain AID-A, for the wireless station 410, and AID-B, for the peer wireless station 420. Thus, while the wireless station 410 is connecting to the wireless communication device 430, the wireless communication device 430 may use AID-A for the wireless station 410 and reserve, dedicate, or allocate AID-B for the peer wireless station 420, in case the peer wireless station 420 subsequently connects to the wireless communication device 430. In some examples, AID-A and AID-B may be consecutive.

As shown by reference number 515, the peer wireless station 420 may transmit, and the wireless communication device 430 may receive, an association request. As shown by reference number 520, the wireless communication device 430 may transmit, and the peer wireless station 420 may receive, an association response. The association response may contain AID-X, for the peer wireless station 420, and AID-Y, for the wireless station 410. Thus, while the peer wireless station 420 is connecting to the wireless communication device 430, the wireless communication device 430 may use AID-Y for the peer wireless station 420 and reserve, dedicate, or allocate AID-X for the wireless station 410. In some examples, AID-X and AID-Y may be consecutive.

As shown by reference number 525, the wireless station 410 may enter a baseline DTIM sleep cycle (e.g., the first DTIM sleep cycle). As shown by reference number 530, the peer wireless station 420 may also enter the baseline DTIM sleep cycle. As shown by reference number 535, the peer wireless station 420 may determine that one or more rules have been met to enter a dynamic DTIM sleep cycle. For example, a power level of the peer wireless station 420 may have dropped below a power level threshold. As shown by reference number 540, the peer wireless station 420 may determine that one or more dynamic DTIM rules (e.g., comparatively low battery) have been met to enter a dynamic DTIM sleep cycle (e.g., the second DTIM sleep cycle). The wireless station 410 may remain in the baseline DTIM sleep cycle.

As shown by reference number 545, the wireless communication device 430 may have pending data (e.g., pending packets) for the peer wireless station 420. As shown by reference number 550, the wireless communication device 430 may transmit, and the wireless station 410 may receive, beacon that includes a TIM update. The beacon may update a TIM IE of the wireless station 410 and/or the peer wireless station 420. For example, during a beacon TIM update of a beacon for the wireless station 410 using AID-A, the wireless communication device 430 may update a TIM for the peer wireless station 420 using AID-B. Similarly, in some examples (not shown in FIG. 5), during a beacon TIM update of a beacon for the peer wireless station 420 using AID-Y, the wireless communication device 430 may update a TIM for the wireless station 410 using AID-X.

As shown by reference number 555, the wireless station 410 may identify that the wireless communication device 430 has pending data for the peer wireless station 420. For example, the wireless station 410 may identify the pending data in response to receiving the beacon that includes the TIM update in a wireless station band of the wireless station 410. As shown by reference number 560, the wireless station 410 may transmit, and the peer wireless station 420 may receive, a wake-up indication. For example, the wireless station 410 may trigger the peer wireless station 420 to wake up over a WPAN (e.g., via BLE). Upon receiving the wake-up indication, the peer wireless station 420 may wake up. As shown by reference number 565, the wireless communication device 430 may transmit, and the peer wireless station 420 may receive, the pending data.

Additionally, or alternatively, the wireless station 410 may receive the indication of the AID over a WPAN associated with the peer wireless station 420, as discussed above in connection with reference number 450 (FIG. 4). For example, while the wireless station 410 is connecting to the wireless communication device 430, the wireless communication device 430 may use AID-A for the wireless station 410, and while the peer wireless station 420 is connecting to the wireless communication device 430, the wireless communication device 430 may use AID-B for the peer wireless station 420. After both wireless station 410 and peer wireless station 420 are connected to the wireless communication device 430, the wireless station 410 and peer wireless station 420 may communicate AID information to each other over the WPAN (e.g., via BLE). For example, the wireless station 410 may transmit, and the peer wireless station 420 may receive, an indication of AID-A, and the peer wireless station 420 may transmit, and the wireless station 410 may receive, an indication of AID-B. The wireless station 410 may enter the baseline DTIM sleep cycle, and the peer wireless station 420 may enter the dynamic DTIM sleep cycle based at least in part on one or more dynamic DTIM rules (e.g., comparatively low battery) being met. The wireless communication device 430 may have pending data (e.g., pending packets) for the peer wireless station 420 and update the TIM in a beacon using AID-B. The wireless station 410 may receive the beacon and identify, using the AID-B, that the wireless communication device 430 has pending data for the peer wireless station 420. The wireless station 410 may transmit, and the peer wireless station 420 may receive, a wake-up indication over a WPAN (e.g., via BLE). Upon receiving the wake-up indication, the peer wireless station 420 may wake up and receive the pending data from the wireless communication device 430.

As indicated above, FIG. 5 is provided as an example. Other examples may differ from what is described with respect to FIG. 5.

The wireless station 410 receiving the indication of the AID associated with the peer wireless station 420 may help to enable the peer wireless station 420 to implement dynamic DTIM (thereby conserving battery power and increasing power savings) and wake up to receive pending data. As a result, a quantity of missed or dropped frames and/or data (e.g., broadcast, multicast, and/or unicast packets) may be reduced. Furthermore, latency due to dynamic (e.g., higher-order) DTIM may be mitigated because the peer wireless station 420 may wake up in the event of pending data.

The wireless station 410 receiving the indication of the AID over the WPAN may help to reduce a quantity of AIDs reserved by the wireless communication device 430, thereby reducing memory and/or processing resource utilization at the wireless communication device 430. For example, the quantity of AIDs may be reduced from four (e.g., two AIDs per wireless station) to two (e.g., one AID per wireless station).

FIG. 6 is a diagram illustrating an example process 600 performed, for example, at a wireless station or an apparatus of a wireless station, in accordance with the present disclosure. Example process 600 is an example where the apparatus or the wireless station (e.g., wireless station 410) performs operations associated with handling pending data using an AID of a peer wireless station.

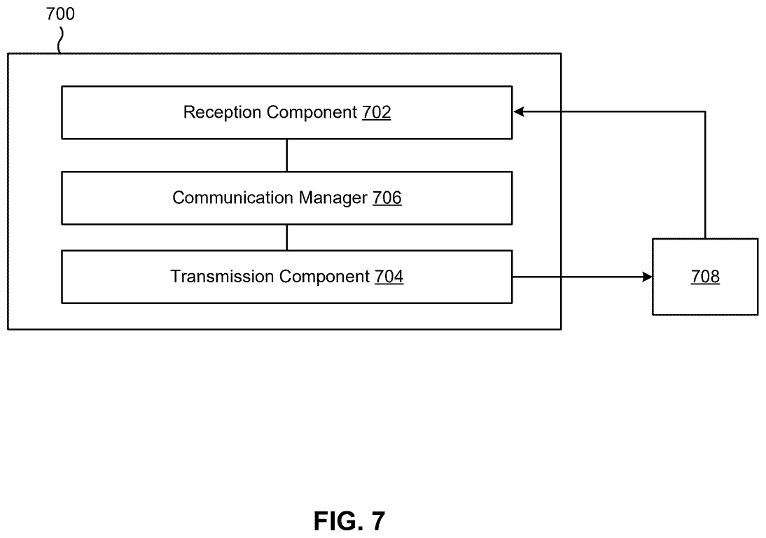

As shown in FIG. 6, in some aspects, process 600 may include receiving an indication of an AID associated with a peer wireless station, wherein the wireless station and the peer wireless station are associated with a wireless communication device (block 610). For example, the wireless station (e.g., using reception component 702 and/or communication manager 706, depicted in FIG. 7) may receive an indication of an AID associated with a peer wireless station, wherein the wireless station and the peer wireless station are associated with a wireless communication device, as described above.

As further shown in FIG. 6, in some aspects, process 600 may include receiving, in accordance with the AID, an indication of pending data associated with the peer wireless station (block 620). For example, the wireless station (e.g., using reception component 702 and/or communication manager 706, depicted in FIG. 7) may receive, in accordance with the AID, an indication of pending data associated with the peer wireless station, as described above.

As further shown in FIG. 6, in some aspects, process 600 may include transmitting, responsive to the indication of the pending data, a wake-up indication over a WPAN associated with the peer wireless station (block 630). For example, the wireless station (e.g., using transmission component 704 and/or communication manager 706, depicted in FIG. 7) may transmit, responsive to the indication of the pending data, a wake-up indication over a WPAN associated with the peer wireless station, as described above.

Process 600 may include additional aspects, such as any single aspect or any combination of aspects described below and/or in connection with one or more other processes described elsewhere herein.

In a first aspect, the AID and an AID associated with the wireless station are consecutive AIDs.

In a second aspect, alone or in combination with the first aspect, the AID is a first AID, the peer wireless station is associated with a second AID, and the wireless station is associated with a third AID and a fourth AID.

In a third aspect, alone or in combination with one or more of the first and second aspects, receiving the indication of the AID includes receiving the indication of the AID over the WPAN.

In a fourth aspect, alone or in combination with one or more of the first through third aspects, the wireless station is associated with a first DTIM sleep cycle, and the peer wireless station is associated with a second DTIM sleep cycle that is longer than the first DTIM sleep cycle.

In a fifth aspect, alone or in combination with one or more of the first through fourth aspects, the wireless station is a wireless audio device, and wherein the peer wireless station is a peer wireless audio device.

In a sixth aspect, alone or in combination with one or more of the first through fifth aspects, the wireless communication device is an AP.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a wireless station, or a wireless station may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 140 described in connection with FIG. 1. As shown, the apparatus 700 may communicate with another apparatus 708, such as a peer wireless station, using the reception component 702 and the transmission component 704. The communication manager 706 may be included in, or implemented via, a processing system (for example, the processing system described in connection with FIG. 3) of the wireless station.

In some aspects, the apparatus 700 may be configured to perform one or more operations described herein in connection with FIGS. 4-5. Additionally, or alternatively, the apparatus 700 may be configured to perform one or more processes described herein, such as process 600 of FIG. 6, or a combination thereof. In some aspects, the apparatus 700 and/or one or more components shown in FIG. 7 may include one or more components of the wireless station described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the wireless station described above in connection with FIG. 1, such as a radio, one or more RF chains, one or more transceivers, or one or more modems, each of which may in turn be coupled with one or more antennas of the wireless station.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the wireless station described above in connection with FIG. 1, such as a radio, one or more RF chains, one or more transceivers, or one or more modems, each of which may in turn be coupled with one or more antennas of the wireless station described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The reception component 702 may receive an indication of an AID associated with a peer wireless station, wherein the wireless station and the peer wireless station are associated with a wireless communication device. The reception component 702 may receive, in accordance with the AID, an indication of pending data associated with the peer wireless station. The transmission component 704 may transmit, responsive to the indication of the pending data, a wake-up indication over a WPAN associated with the peer wireless station.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed by a wireless station, comprising: receiving an indication of an association identifier (AID) associated with a peer wireless station, wherein the wireless station and the peer wireless station are associated with a wireless communication device; receiving, in accordance with the AID, an indication of pending data associated with the peer wireless station; and transmitting, responsive to the indication of the pending data, a wake-up indication over a wireless personal area network (WPAN) associated with the peer wireless station.
Aspect 2: The method of Aspect 1, wherein the AID and an AID associated with the wireless station are consecutive AIDs.
Aspect 3: The method of any of Aspects 1-2, wherein the AID is a first AID, the peer wireless station is associated with a second AID, and the wireless station is associated with a third AID and a fourth AID.
Aspect 4: The method of any of Aspects 1-3, wherein receiving the indication of the AID includes receiving the indication of the AID over the WPAN.
Aspect 5: The method of any of Aspects 1-4, wherein the wireless station is associated with a first delivery traffic indication message (DTIM) sleep cycle, and the peer wireless station is associated with a second DTIM sleep cycle that is longer than the first DTIM sleep cycle.
Aspect 6: The method of any of Aspects 1-5, wherein the wireless station is a wireless audio device, and wherein the peer wireless station is a peer wireless audio device.
Aspect 7: The method of any of Aspects 1-6, wherein the wireless communication device is an access point (AP).
Aspect 8: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-7.
Aspect 9: An apparatus for wireless communication at a device, the apparatus comprising one or more memories and one or more processors coupled to the one or more memories, the one or more processors configured to cause the device to perform the method of one or more of Aspects 1-7.
Aspect 10: An apparatus for wireless communication, the apparatus comprising at least one means for performing the method of one or more of Aspects 1-7.
Aspect 11: A non-transitory computer-readable medium storing code for wireless communication, the code comprising instructions executable by one or more processors to perform the method of one or more of Aspects 1-7.
Aspect 12: A non-transitory computer-readable medium storing a set of instructions for wireless communication, the set of instructions comprising one or more instructions that, when executed by one or more processors of a device, cause the device to perform the method of one or more of Aspects 1-7.
Aspect 13: A device for wireless communication, the device comprising a processing system that includes one or more processors and one or more memories coupled with the one or more processors, the processing system configured to cause the device to perform the method of one or more of Aspects 1-7.
Aspect 14: An apparatus for wireless communication at a device, the apparatus comprising one or more memories and one or more processors coupled to the one or more memories, the one or more processors individually or collectively configured to cause the device to perform the method of one or more of Aspects 1-7.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, the phrase “based on” is intended to mean “based at least in part on” or “based on or otherwise in association with” unless explicitly stated otherwise.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a wireless station, comprising:
one or more memories; and
one or more processors coupled to the one or more memories, the one or more processors individually or collectively configured to cause the wireless station to:
receive an indication of an association identifier (AID) associated with a peer wireless station, wherein the wireless station and the peer wireless station are associated with a wireless communication device;
receive, in accordance with the AID, an indication of pending data associated with the peer wireless station; and
transmit, responsive to the indication of the pending data, a wake-up indication over a wireless personal area network (WPAN) associated with the peer wireless station.

2. The apparatus of claim 1, wherein the AID and an AID associated with the wireless station are consecutive AIDs.

3. The apparatus of claim 1, wherein the AID is a first AID, the peer wireless station is associated with a second AID, and the wireless station is associated with a third AID and a fourth AID.

4. The apparatus of claim 1, wherein the one or more processors, to cause the wireless station to receive the indication of the AID, are configured to cause the wireless station to receive the indication of the AID over the WPAN.

5. The apparatus of claim 1, wherein the wireless station is associated with a first delivery traffic indication message (DTIM) sleep cycle, and the peer wireless station is associated with a second DTIM sleep cycle that is longer than the first DTIM sleep cycle.

6. The apparatus of claim 1, wherein the wireless station is a wireless audio device, and wherein the peer wireless station is a peer wireless audio device.

7. The apparatus of claim 1, wherein the wireless communication device is an access point (AP).

8. A method of wireless communication performed by a wireless station, comprising:
receiving an indication of an association identifier (AID) associated with a peer wireless station, wherein the wireless station and the peer wireless station are associated with a wireless communication device;
receiving, in accordance with the AID, an indication of pending data associated with the peer wireless station; and
transmitting, responsive to the indication of the pending data, a wake-up indication over a wireless personal area network (WPAN) associated with the peer wireless station.

9. The method of claim 8, wherein the AID and an AID associated with the wireless station are consecutive AIDs.

10. The method of claim 8, wherein the AID is a first AID, the peer wireless station is associated with a second AID, and the wireless station is associated with a third AID and a fourth AID.

11. The method of claim 8, wherein receiving the indication of the AID includes receiving the indication of the AID over the WPAN.

12. The method of claim 8, wherein the wireless station is associated with a first delivery traffic indication message (DTIM) sleep cycle, and the peer wireless station is associated with a second DTIM sleep cycle that is longer than the first DTIM sleep cycle.

13. The method of claim 8, wherein the wireless station is a wireless audio device, and wherein the peer wireless station is a peer wireless audio device.

14. The method of claim 8, wherein the wireless communication device is an access point (AP).

15. An apparatus for wireless communication, comprising:
means for receiving an indication of an association identifier (AID) associated with a peer apparatus, wherein the apparatus and the peer apparatus are associated with a wireless communication device;
means for receiving, in accordance with the AID, an indication of pending data associated with the peer apparatus; and
means for transmitting, responsive to the indication of the pending data, a wake-up indication over a wireless personal area network (WPAN) associated with the peer apparatus.

16. The apparatus of claim 15, wherein the AID and an AID associated with the apparatus are consecutive AIDs.

17. The apparatus of claim 15, wherein the AID is a first AID, the peer apparatus is associated with a second AID, and the apparatus is associated with a third AID and a fourth AID.

18. The apparatus of claim 15, wherein the means for receiving the indication of the AID includes means for receiving the indication of the AID over the WPAN.

19. The apparatus of claim 15, wherein the apparatus is associated with a first delivery traffic indication message (DTIM) sleep cycle, and the peer apparatus is associated with a second DTIM sleep cycle that is longer than the first DTIM sleep cycle.

20. The apparatus of claim 15, wherein the apparatus is a wireless audio device, and wherein the peer apparatus is a peer wireless audio device.
